(19) United States
(12) Patent Application Publication
(10) Pub. No.: US 2003/0123579 A1
(43) Pub. Date: Jul. 3, 2003

(54) Viterbi convolutional coding method and apparatus

(76) Inventors: Saeid Safavi, San Diego, CA (US); Afshin Niktash, Irvine, CA (US); Behzad Barjesteh Mohebbi, Tustin, CA (US); Fadi Joseph Kurdahi, Irvine, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/298,249

(22) Filed: Nov. 15, 2002

Related U.S. Application Data
(60) Provisional application No. 60/332,398, filed on Nov. 16, 2001.

(51) Int. Cl. H04L 27/06

(52) U.S. Cl. 375/341

(57) ABSTRACT

A method and apparatus for executing a Viterbi decoding routine, in which the routine is mapped to an array of interconnected reconfigurable processing elements. The processing elements function in parallel, and pass results to other processing elements to reduce the number of processing steps for executing the Viterbi decoding routine. Accordingly, the present invention may be used to perform the decoding routine with any number of constraint lengths and code rates, and be independent of a specific communication standard. Further, the present invention reduces power consumption and area in the use of circuits for performing the coding routine.

### BACKGROUND OF THE INVENTION

This patent application claims priority from U.S. Provisional Patent Application No. 60/332,398, filed Nov. 16, 2001, entitled “VITERBI CONVOLUTIONAL CODING METHOD AND APPARATUS.” This application is also related to U.S. Pat. No. 6,448,910 to Lu and assigned to Morpho Technologies, Inc., entitled “METHOD AND APPARATUS FOR CONVOLUTION ENCODING AND VITERBI DECODING OF DATA THAT UTILIZE A CONFIGURABLE PROCESSOR TO CONFIGURE A PLURALITY OF RE-CONFIGURABLE PROCESSING ELEMENTS,” and which is incorporated by reference herein for all purposes.

The present invention generally relates to digital encoding and decoding. More particularly, this invention relates to a method and apparatus for executing a Viterbi convolutional coding algorithm using a multi-dimensional array of programmable elements.

Convolutional encoding is widely used in digital communication and signal processing to protect transmitted data against noise. Convolutional encoding is a technique that systematically adds redundancy to a bitstream of data. Input bits to a convolutional encoder are convolved in a way in which each bit can influence the output more than once.

The so-called second and third generation (2G/3G) communication standards IS-95, CDMA2000, WCDMA and TD-SCDMA, use convolutional codes having a constraint length of 9 with different code rates. The rate of the encoder is the ratio of the number of input bits to output bits of the encoder. For example, CDMA2000 has code rates of ½, ⅓, ¼ and ⅙, while WCDMA/TD-SCDMA have code rates of ½ and ⅓. The Global System for Mobile (GSM) standard uses a constraint length of 5, and IEEE 802.11 a employs convolutional encoders which use a constraint length of 7.

FIGS. 1A and 1B show simplified block diagrams of WCDMA convolutional encoders with respective code rates of ½ and ⅓. Convolutional encoding involves the modulo-2 addition of selected taps of a data sequence that is serially time-delayed by a number of delay elements (D) or shift registers. The length of the data sequence delay is equal to K-1, where K is the number of stages in each shift register, also called the constraint length of the code.

Each input bit enters a shift register/delay element, and the output is derived by combining the bits in the shift register/delay element in a way determined by the structure of the encoder in use. Thus, every bit that is transmitted influences the same number of outputs as there are stages in the shift register. The output bits are transmitted through a communication channel and are decoded by employing a decoder at the receiving end.

One approach for decoding a convolutional encoded bit stream at a receiver is to use a Viterbi algorithm. The Viterbi algorithm operates by finding the most likely state transition sequence in a state diagram. In a decoding process, the Viterbi algorithm includes the following decoding steps: 1) Branch Metrics Calculation; 2) Add-Compare and Select; and 3) Survivor Paths Storage. Survivor paths decoding is carried out using two possible approaches: Trace Back or Register-Exchange. These steps and associated approaches will be explained in further detail.

Convolutional encoding and decoding, and in particular Viterbi decoding, are processing-intensive, and consume large amounts of processing resources. Accordingly, there is a need for a system and method in which convolutional codes can be processed efficiently and at high speed. Further, there is a need for a platform for executing a method which can be used in any one of a number of current or future wireless communication standards.

### BRIEF DESCRIPTION OF THE FIGURES

FIG. 1A shows a convolutional encoder for WCDMA with a code rate of ½.

FIG. 1B shows a convolutional encoder for WCDMA with a code rate of ⅓.

FIG. 2 is a simplified block diagram of a reconfigurable digital signal processor for executing a Viterbi algorithm.

FIG. 3 is a detailed block diagram of a reconfigurable digital signal processor for executing a Viterbi algorithm.

FIG. 4 is a trellis diagram illustrating a trace-back method.

FIG. 5 shows a register exchange method.

FIG. 6 shows a state diagram of a trellis for a Viterbi decoder employed in CDMA2000/WCDMA with a constraint length of 9 and a rate of ½.

FIG. 7 is a state diagram of an assignment to an 8×8 array of reconfigurable cells (RC array) for a Viterbi decoder employed in CDMA2000/WCDMA according to an embodiment.

FIG. 8 illustrates a collapse process for one row of the RC array.

FIG. 9 shows a data re-shuffle process for a column of the RC array.

FIG. 10 illustrates state path metrics locations after a column data re-shuffle within the RC array.

FIG. 11 shows a Viterbi flow chart for execution by an RC array, in accordance with an embodiment.

FIG. 12 shows a trace-back method in a hybrid approach.

FIG. 13 illustrates a sliding window method and a direct metric transfer method.

FIG. 14 is a block diagram of a modular comparison stage in ACS.

FIG. 15 is a flowchart of an optimized Viterbi method in accordance with an embodiment.

FIG. 16 is a table showing the effect on cycle count by parallel execution of multiple Viterbi decoders.

FIG. 17 is a state allocation table for four parallel Viterbi decoders.

FIG. 18 shows shuffling for a Viterbi decoding routine for IEEE 802.11a executed on two rows of an RC array according to an embodiment.

FIG. 19 shows shuffling for a Viterbi coding routine for WCDMA executed on two rows of an RC array according to an alternative embodiment.

FIG. 20 illustrates a software simulation of a bit error rate performance of one embodiment.

FIG. 21 illustrates an actual simulation of bit error rate performance of a particular architecture.

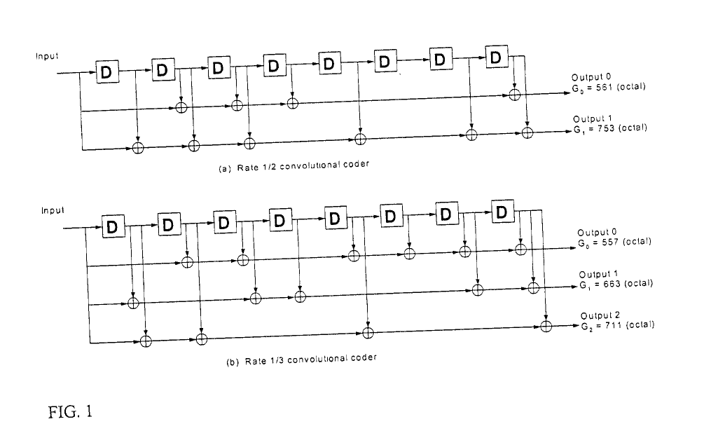

### DETAILED DESCRIPTION OF THE PREFERRED EMBODIMENTS

Methods for decoding signals that have been encoded by a convolutional encoding scheme are disclosed herein. One method includes configuring a portion of an array of independently reconfigurable processing elements for performing a special Viterbi decoding algorithm. The method further includes executing the Viterbi decoding routine on data blocks received at the configured portion of the array of processing elements.

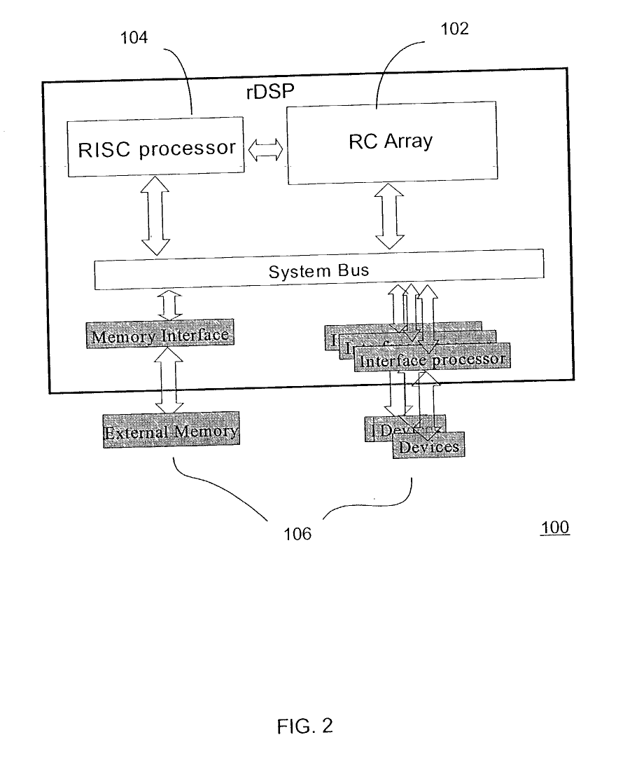

FIG. 2 illustrates a simplified block diagram of a reconfigurable DSP (rDSP) 100 designed by Morpho Technologies, Inc., of Irvine Calif., and the assignees hereof. The rDSP 100 includes a reconfigurable processing unit 102 comprising an array of reconfigurable processing cells (RCs). The rDSP 100 further includes a general-purpose reduced instruction set computer (RISC) processor 104 and a set of I/O interfaces 106, all of which can be implemented as a single chip. The RCs in the RC array 102 are coarse-grain, but also provide extensive support for key bit-level functions. The RISC processor 104 controls the operation of the RC array 102. The input/output (I/O) interfaces 106 handle data transfers between external devices and the rDSP 100. Dynamic reconfiguration of the RC array can be done in one cycle by caching on the chip several contexts from an off-chip memory (not shown).

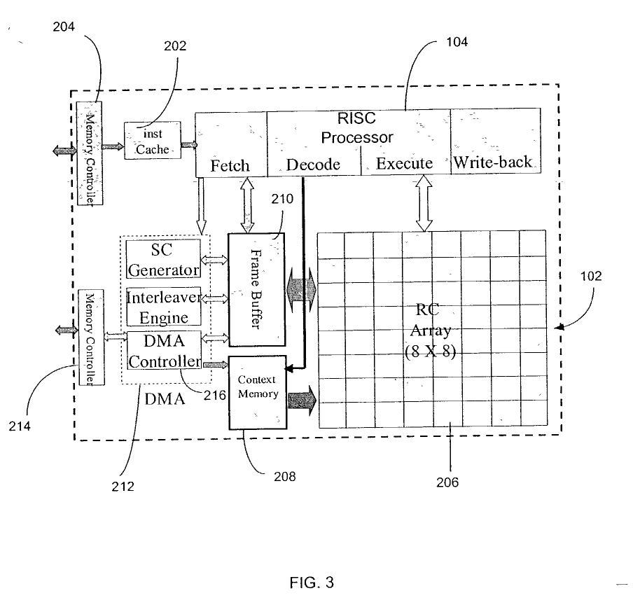

FIG. 3 illustrates an rDSP chip 200 in greater detail, showing: the RISC processor 104 with its associated instruction cache 202 and memory controller 204; an RC array 102 comprising an 8-row by 8-column array of RCs 206; a context memory 208; a frame buffer 210; and a direct memory access 212 with its coupled memory controller 214. Each RC includes several functional units (e.g. MAC, arithmetic logic unit, etc.) and a small register file, and is preferably configured through a 32-bit context word, however other bit-lengths can be employed.

The frame buffer 210 acts as an internal data cache for the RC array 102, and can be implemented as a two-port memory. The frame buffer 210 makes memory accesses transparent to the RC array 102 by overlapping computation processes with data load and store processes. The frame buffer 210 can be organized as 8 banks of N×16 frame buffer cells, where N can be sized as desired. The frame buffer 210 can thus provide 8 RCs (1 row or 1 column) with data, either as two 8-bit operands or one 16-bit operand, on every clock cycle.

The context memory 208 is the local memory in which to store the configuration contexts of the RC array 102, much like an instruction cache. A context word from a context set is broadcast to all eight RCs 206 in a row or column. All RCs 206 in a row (or column) can be programmed to share a context word and perform the same operation. Thus the RC array 102 can operate in Single Instruction, Multiple Data form (SIMD). For each row and each column there may be 256 context words that can be cached on the chip. The context memory can have a 2-port interface to enable the loading of new contexts from off-chip memory (e.g. flash memory) during execution of instructions on the RC array 102.

RC cells 206 in the array 102 can be connected in two levels of hierarchy. First, RCs 206 within each quadrant of 4×4 RCs can be fully connected in a row or column. Furthermore, RCs 206 in adjacent quadrants can be connected via “fast lanes”, or high-speed interconnects, which can enable an RC 206 in a quadrant to broadcast its results to the RCs 206 in adjacent quadrants.

The RISC processor 104 handles general-purpose operations, and also controls operation of the RC array 102. It initiates all data transfers to and from the frame buffer 210, and configuration loads to the context memory 208 through a DMA controller 216. When not executing normal RISC instructions, the RISC processor 104 controls the execution of operations inside the RC array 102 every cycle by issuing special instructions, which broadcast SIMD contexts to RCs 206 or load data between the frame buffer 210 and the RC array 102. This makes programming simple, since one thread of control flow is running through the system at any given time.

In accordance with an embodiment, a Viterbi algorithm is divided into a number of sub-processes or steps, each of which is executed by a number of RCs 206 of the RC array 102, and the output of which is used by other same or other RCs 206 in the array. Embodiments of the Viterbi decoding steps, configured generally for a digital signal processor and in some cases specifically for an rDSP, will now be described in greater detail.

### Branch Metrics Calculation

The branch metric is the squared Euclidean distance between the received noisy symbol, yₙ (soft decision valued), and the ideal noiseless output symbol of that transition for each state in the trellis. That is, the branch metric for the transition from state i to state j at the trellis stage n is

Bᵢⱼ(n)=(yₙ−Cᵢⱼ(n))² (Eq. 1-1)

Where Cᵢⱼ(n) is the ideal noiseless output symbol of the transition from state i to state j. If Mⱼ(n) is defined as the path metric for state j at trellis stage n and {i} as the set of states that have transitions to state j, then the most likely path coming into state j at trellis stage n is the path that has the minimum metric:

$${M}_{j} ( n ) = {min}_{\{ i \}} [ {M}_{i} ( n - 1 ) + {B}_{ij} ( n ) ] \qquad ( \text{Eq. 1-2} )$$

After the most likely transition to state j at trellis stage n is computed, the path metric for state j, Mⱼ(n) is updated and this most likely transition, say from state m to state j, is appended to the survivor path of state m at stage (n−1) so as to form the survivor path of state j at the stage n.

According to one embodiment, only the differences between the branch metrics in (Eq. 1-1) are evaluated, thus the terms yₙ² in the branch metrics will be subtracted from each other during comparison. Further, for anti-podal signaling where the transition output symbols are binary and represented by −a and a (i,e. Cᵢⱼ ε{−a, a}, a>0) the term (Cᵢⱼ)² is always a constant, a². Thus, comparing the branch metric between state i and state j, Bᵢⱼ(n) to the branch metric between state k and state j, Bₖⱼ(n), yields:

$${B}_{ij} ( n ) - {B}_{kj} ( n ) = \{ \begin{matrix}0 \\ - 2 {y}_{n} {C}_{i , j} + 2 {y}_{n} {C}_{k , j}\end{matrix} \begin{matrix}for {C}_{ij} = {C}_{k , j} \\ for {C}_{i , j} \neq {C}_{k , j}\end{matrix} \qquad ( \text{Eq. 1-3} )$$

If all the branch metrics are divided by a constant 2a, the comparison results will remain unchanged. Thus, the branch metrics can be represented as:

$${B}_{ij} ( n ) = - {y}_{n} {C}_{ij} = \{ \begin{matrix}- {y}_{n} \\ {y}_{n}\end{matrix} \begin{matrix}for {C}_{i , j} = a \\ for {C}_{i , j} = - a\end{matrix} \qquad ( \text{Eq. 1-4} )$$

Therefore, only negation operations are required to compute the branch metrics. For example, if the ideal symbol is (0,1) and the received noisy symbol is (yₙ, yₙ₊₁), then the branch metric is yₙ+(−yₙ₊₁).

If Bᵢⱼ(n) is defined as:

$${B}_{ij} ( n ) = {y}_{n} {C}_{ij} = \{ \begin{matrix}{y}_{n} \\ - {y}_{n}\end{matrix} \begin{matrix}for {C}_{i , j} = a \\ for {C}_{i , j} = - a\end{matrix} \qquad ( \text{Eq. 1-5} )$$

Accordingly, the maximum path metrics can be chosen, which gives the maximum confidence of the path.

### Add, Compare and Select

After the branch metrics associated with each transition are calculated, they will be added to previous accumulated branch metrics of the source of transition to build path metrics. Thus for every next-state there will be 2 paths, with two different path metrics. The new accumulated branch metric of each next state is the path metrics with maximum likelihood, which is in a preferred case the maximum of two path metrics.

### Survivor Path Storage

The path metric associated with each state should be stored in each stage to be used for decoding. The amount of memory to be allocated for storage depends on trace back or register exchange decoding scheme, as well as the length of the block.

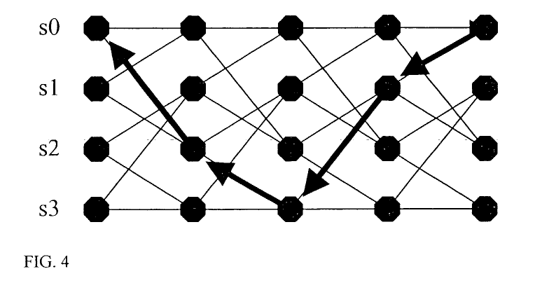

In a “trace-back” method, the survivor path of each state is stored. One bit is assigned to each state to indicate if the survivor branch is the upper or the lower path. Furthermore, the value of the accumulated branch metric is also stored for a next trellis stage. Using the one-bit information of each state, it is possible to trace back the survivor path starting from the final stage. The decoded output sequence can be obtained from the identified survivor path through the trellis. FIG. 4 shows this method.

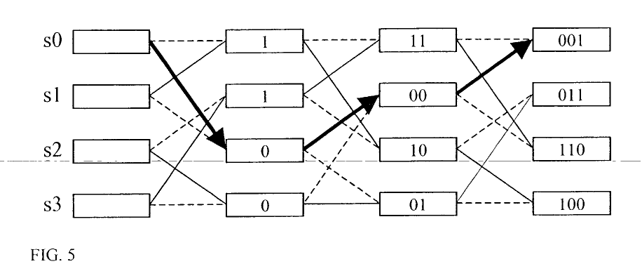

FIG. 5 illustrates a “register exchange” method, in which a register is assigned to each state, and contains information bits for the survivor path from the initial state to the current state. The register keeps the partially decoded output sequence along the path. The register exchange approach eliminates the need to trace back, since the register of the final state contains the decoded output sequence. However the register exchange approach uses more hardware resources due to the need to copy the contents of all the registers in one stage to the next stage.

### Mapping of the Viterbi Algorithm

The Viterbi algorithm according to an embodiment is mapped to a selected subset of RCs 206 in the RC array 102. An exemplary mapping is based on K=9 and R=½. However, this approach is applicable for other K and R values. The same approach can also be adapted for a generic mapping, so that the same hardware can be used for different applications. The basic mapped code includes 6 stages, the development of which is discussed further below.

### State Assignments to RCs

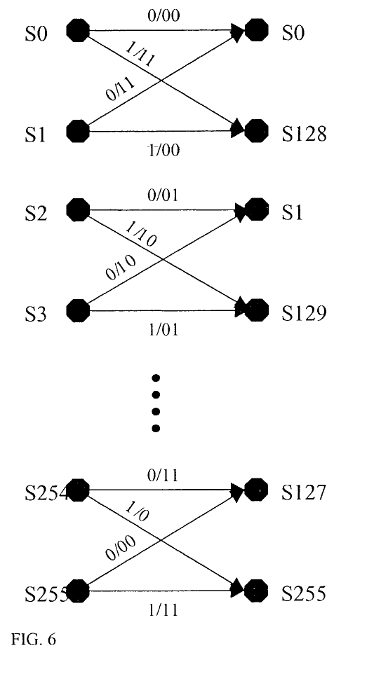

For the case of CDMA2000/WCDMA with constraint length of 9 and rate of ½, the state transitions can be represented in a trellis diagram as shown in FIG. 6. Input and output of a convolutional encoder corresponding to this trellis diagram is stated for each branch. For example, 0/11 means that input 0 in the encoder will generate output 11 corresponding to polynomial G₀, G₁. As shown, the probable next states for every state pair are the same. The next states of present state Sᵢ is:

next(Sᵢ)={Sⱼ|j=128t+floor(i/2), t=0,1} (Eq. 2-1)

Since there are 256 states in each trellis stage, each RC 206 will have 4 states. The present states and next states are assigned to the RCs as:

PresentStates(RCᵢ)={S₄ᵢ, S₄ᵢ₊₁, S₄ᵢ₊₂, S₄ᵢ₊₃}, iε{0, 1, . . . , 63} (Eq. 2-2)

NextStates(RCᵢ)={next(S₄ᵢ), next(S₄ᵢ₊₂)}, i ε{0, 1, . . . , 63} (Eq. 2-3)

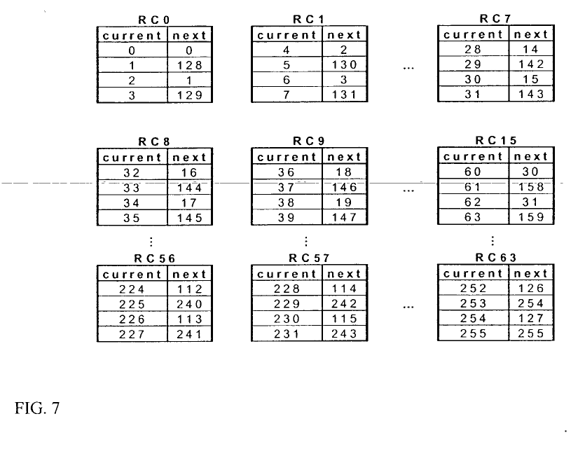

FIG. 7 shows the assigned current and next state to each RC.

### Stage 1: Branch Metrics Calculation

The operation of branch metrics calculation is based on (Eq. 1-5) above. The incoming soft data y₁, y₂ are assumed to be in a group, which correspond to the output data in the encoder (½) for a certain input. Exemplary computer code below shows the calculation:

for (k=0; k< FRAME_LENGTH; k++)

{

b₀₀[k]=−y₁[k]−y₂[k];

b₀₁[k]=−y₁[k]+y₂[k];

b₁₀[k]=+y₁[k]−y₂[k];

b₁₁[k]=+y₁[k]+y₂[k];

};

where b₀₀[k] through b₁₁[k] are branch metrics associated with convolutional encoder output of 00 to 11, as shown in FIG. 6. Because b₀₀[k]=−b₁₁[k], b₀₁[k]=−b₁₀[k], it can be further optimized for different RCs 206 as:

for (k=0; k< FRAME_LENGTH; k++)

{

b₁₀[k]=y₁[k]−y₂[k;

b₁₁[k]=y₁[k]+y₂[k];

};

As can be seen from FIG. 6, b₀₀[k] through b₁₁[k] have to be computed for every RC. Thus it is sufficient to calculate only b₁₀[k] and b₁₁[k] at every iteration and add to/subtract from proper accumulated branch metrics in ADC stage. In order to do the add or subtract on different RCs at the same time, a condition register is used with bits associated with conditions required in each RC 206 through different stages.

For example, RC 0 in FIG. 7 has current states 0, 1, 2, 3. For the state group 0 and 1, they need the branch metrics b₁₁ and −b ₁₁, for the state group 2 and 3, they need branch metrics −b₁₀ and b₁₀. But for RC 2 with current states 8,9,10,11 the required branch metrics for group 0 (8,9) are −b₁₀ and b₁₀ and for group 1(10,11) are b₁₁ and −b₁₁. This order further changes in other RCs.

The encoded data is assumed to be 8-bit signed, referred to as a soft input. The operations in this stage, and required number of cycles, are:

| | |
|---|---|
| Set flag based on pre-defined condition (cond 1) | 1 cycle |
| Load Y₁ [k] Y₂ [k] to all of the RCs from Frame Buffer and | 1 cycle |
| perform Y₁ [k] (+/−) Y₂ [k] based on flag: | |
| Perform Y₁ [k] (−/+) Y₂ [k] based on flag: | 1 cycle |

### Stage 2: Add, Compare & Select

In this stage, the proper branch metric is added to/subtracted from current path metric of each present state, then for every next state the incoming path metrics to that state are compared, and the greater one is chosen as the new path metric of the next state. As there are 4 current and 4 next states associated with every RC 206, the incoming path metrics of each next state are examined one-by-one, 64 at a time, over the entire RC array 102.

Registers R0 to R3 are assigned for current state path metrics and are reused for the next state. The steps for computing path metrics of first 2 next states are as follows. The second group of next states can be updated with similar steps.

| | |
|---|---|
| The following steps are applied to state 4K and state 4K + 1 | |
| Set flag based on pre-defined condition (cond 2): | 1 cycle |
| Reg 11 = reg 0 +/− Branch metrics 1: | 1 cycle |
| Reg 12 = reg 0 −/+ Branch metrics 1: | 1 cycle |
| Reg 0 = reg 1 −/+ Branch metrics 1: (r0 used as temp. reg) | 1 cycle |
| Reg 8 = reg 1 +/− Branch metrics 1: | 1 cycle |
| Set flag based on reg 0 − reg 11: | 1 cycle |
| If flag=1, then reg 0 = reg 11 else reg 0 = reg 0: | 1 cycle |
| If flag=1, then reg 5 = 0 else reg 5=1: | 1 cycle |
| Set flag based on reg 8 − reg 12: | 1 cycle |
| If flag=1, then reg 1 = reg 12 else reg 1=reg 8: | 1 cycle |
| If flag=1, then reg 6 = 0 else reg 6=1: | 1 cycle |

In this approach the result of add, compare, and select is used to update assigned next states of each RC 206 as well as to keep track of the survivor path using a single bit 0 or 1 associated with upper or lower previous state respectively. This approach has been modified for optimization purposes, and will be discussed further below.

### Stage 3: Storing Survivor Path

In this stage, the survivor path ending of each state is stored in the frame buffer 210. However, as there may be a single bit representing the survivor path of each state, the single bits are first packed into bytes and then the final 8 words (16 bits) are stored.

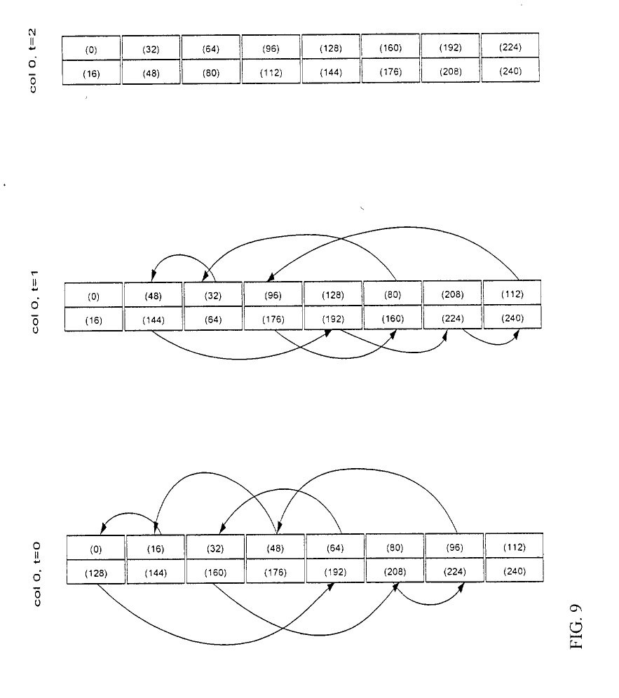

Since each RC 206 has 4 bits of data needing to be stored in the frame buffer 210, the first two bits in RCs 206 in each column will collapse into a 16-bit data word. The second two bits will collapse into another 16-bit data word. The collapse procedure of the first column of RCs is shown in FIG. 9.

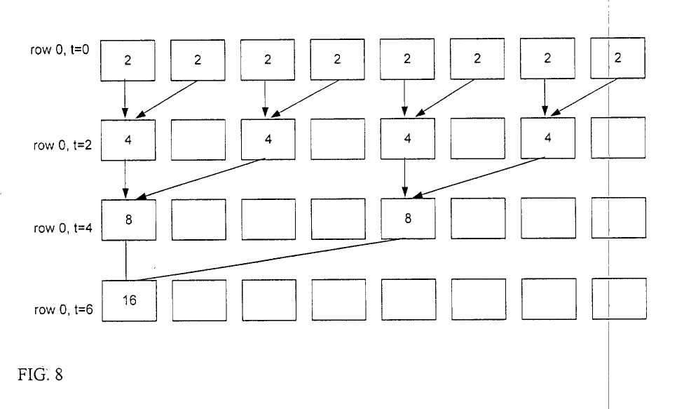

There are two steps to collect the path information bits in each RC 206. The first step is to collect the path information of state 0 through state 127, distributed in 64 RCs as shown in FIG. 8, then the second step is to collect the information of states 128 to 255. The following sub-step shows the detailed procedure of each major step. In the following case, the contexts are broadcast to a row. The following procedures are used to collect the transition information of state 0 to 127.

| | |
|---|---|
| Left shift by 14, 12, 10, 8, 6, 4, 2 for the col 0, 1, 2, 3, 4, 5, | 1 cycle |
| 6, 7: | |
| Assemble the col 0 and 1, col 2 and 3, col 4 and 5, col 6 and 7 | 1 cycle |
| into four 4-bit data: | |
| Assemble the col 0 and 2, col 4 and 6 into two 8-bit data: | 1 cycle |
| Assemble the col 0 and 4 into 16-bit data: | 1 cycle |
| Write out data: | 1 cycle |
| The above procedure is repeated for the transition information of | |
| states 128 to 255. | |

The result is stored in the frame buffer 210. This stage can also be modified for optimization, which will be discussed below.

### Stage 4: State Re-Ordering

In this step, the updated state metrics (next field) need to be moved into the original order (current field) as shown in FIG. 7, so that the same procedures can be applied to the next trellis stage. As the same registers are used for next state and present states, this step is applied to R0-R3. Re-ordering requires both column-wise context broadcast and row-wise context broadcast. The first and second steps are used to exchange the data in row-wise and column-wise modes, respectively.

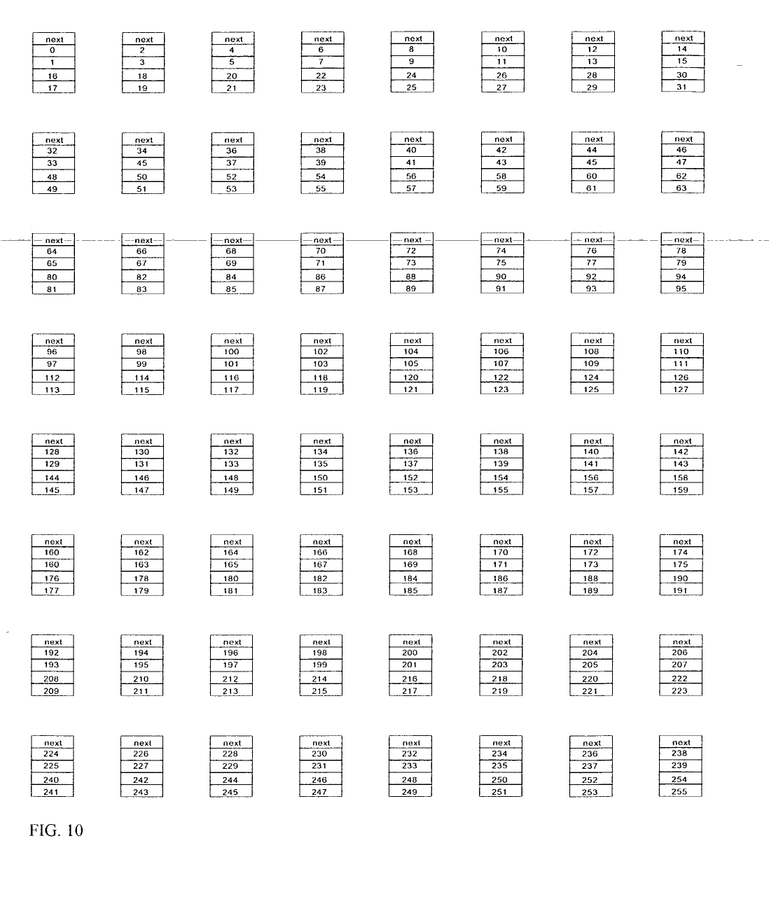

FIG. 9 shows the data re-shuffle for the first group of state path metrics in the first column between different rows, in 2 clock cycles. FIG. 10 shows the path metrics location in the RC array 102 after row data exchange. Since there are two groups of data in each RC 206, it will take 4 clock cycles to completely re-shuffle between rows.

### Stage 5: Finding Maximum Matrix

In order to choose the most probable end state of the trellis, there could be a maximum finder stage to compare path metrics of all states and to pick the path metrics with greatest value. Although in convolutional encoding, there are usually zero tail bits appended to the end of input data to take the trellis to state “zero,” if the segment size is large and a smaller block is used instead, then this stage may be beneficial.

In this stage, path metrics of all states in each RC 206 are compared and the largest one chosen and its index recorded. Then the comparison is carried out between neighbor RCs 206 in each row, and finally between the largest value of rows. As this stage may provide negligible performance improvements, it may be eliminated in other embodiments.

### Trace Back

This stage is for decoding the bits based on the survivor path ending to state 0 (or with maximum path metrics). As the survivor paths of all states have been stored in the frame buffer 210, this stage moves backward from the last state to the first state using the up-low bit of each state to find its previous state. The decoded bit corresponding to every state transition is also identified. An example computer program code below shows the execution of the trace back process:

State=‘00000000’;
Next_addr = start_addr;
Next_base = start_addr;
for (i=n−1; i>=0; i- -) {

trans [i] = read_data@next_addr;
prev = (state & 127) <<1;
trans_bit = (state & 128) >>7;
bitpos = (255 − state) % 8;
branch = (trans [i] >>bitpos) & 1;
state = prev | branch;
next_base = next_base − 4;
next_addr = next_base + state >> 6 + (state & 7);

}

### RC Array Mapping Optimization

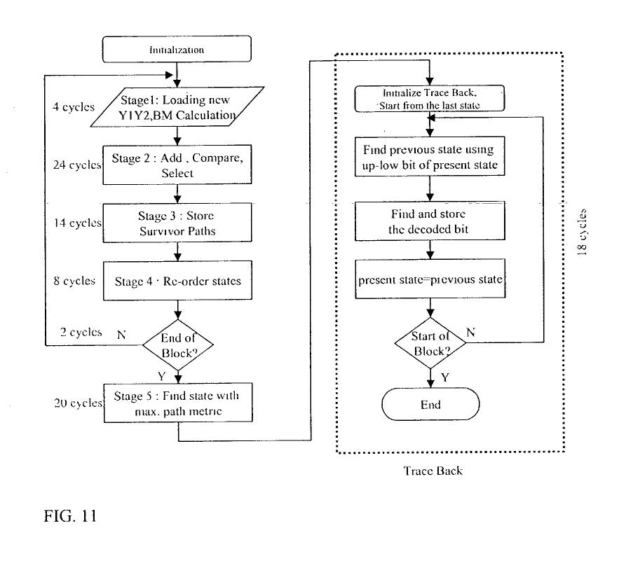

In order to optimize the mapping, the execution flow is discussed. As shown in FIG. 11, the total execution cycle in trace forward is 52 cycles. Stage five will be executed once per block, so the portion of its execution load per bit is negligible. The trace back stage takes 18 cycles per bit. There will be an overhead of about 10% for index addressing and loops. Thus, employing the mapping shown in FIG. 11 will result in about 77 cycles per decoded bit.

In this evaluation, the effect of block overlap is neglected. When the size of the input stream is large, the input sequence can be divided into small-sized blocks. This will reduce the delay between input stream and decoded output. Also, memory assigned to survivor paths can be conserved. The partitioned blocks should have an overlap of about 5*constraint lengths to prevent errors in the decoding of heading or tailing bits of each block. This will be discussed later in detail.

### Hybrid Register Exchange and Trace-Back

As shown in FIG. 11, the trace back stage takes up a large portion of the total number of cycles. As an alternative to trace back, a register-exchange method similar to that explained above can be used for decoding each transmitted bit while doing trace forward.

In this approach, the transmitted bit associated with each transaction from present state to next state and for all states is decoded. This growing bit sequence is kept, so that after choosing the final state the bit sequence associated with that state will be the decoded bits. However, this growing decoded bit sequence should be stored within the RCs 206 and for each state. For large trellis sizes, this may become impractical. Furthermore, this sequence should be re-ordered as the next state in stage 4 is re-shuffled, so that it moves to the correct RC, which could lead to stage 4 being complicated and time-consuming.

An alternative is to use a hybrid “register-exchange and trace-back” method. In this method, the bit sequence is kept for a certain number of stages n, then stored into memory. Eventually, instead of keeping the up-low bit in memory to find the correct survivor path, segments of decoded bits are kept for each path. In the trace back stage, after finding the survivor state, decoded bits of the preceding n stages can be accessed. The trace back for every state need not be done. After finding one state and picking the n decoded bit sequence, the method can jump to the n^{th} preceding stage (present stage-n). This approach shares the effect of trace back cycles over n bits, so that the portion of trace back cycles on total cycles/decoded bit will be reduced from 18 to 18/n, assuming that trace back requires 18 cycles per iteration.

The number of cycles required in stage 3 can also reduced, as the up-low bits do not need to be packed, and the survivor path does not need to be stored at every iteration but only in every n^{th} iteration. One possible drawback of this approach can be found at stage 4. The re-ordering (re-shuffling) stage is more time consuming due to re-ordering of decoded bit registers.

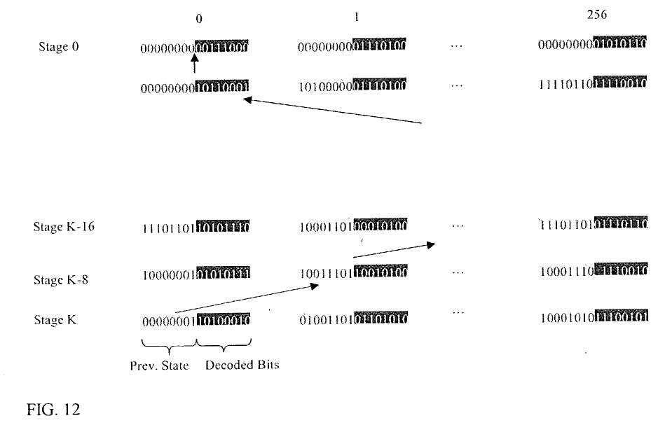

In one embodiment, the optimum n is 16, in which a single register per state is used for decoded bits. Up to a 35% reduction in the number of cycles required can be realized. FIG. 12 shows the hybrid method using a single 16 bit register for a decoded bit sequence of each state. Note that in order to keep track of the survivor path, a way of recording the previous state at every n stage is needed. Due to the reordering of this register between stages, the initial state of each register at first stage is not known. It may not be sufficient to include only a single up-low bit to specify the previous state. Therefore 8 bits (MSB) of this register can be assigned to the index of the previous state, that is, 256 possible states. Although the need for a previous state index decreases n from 16 to 8, it still reduces the total cycles by about 30%.

### Segment Overlapping in Trace Back

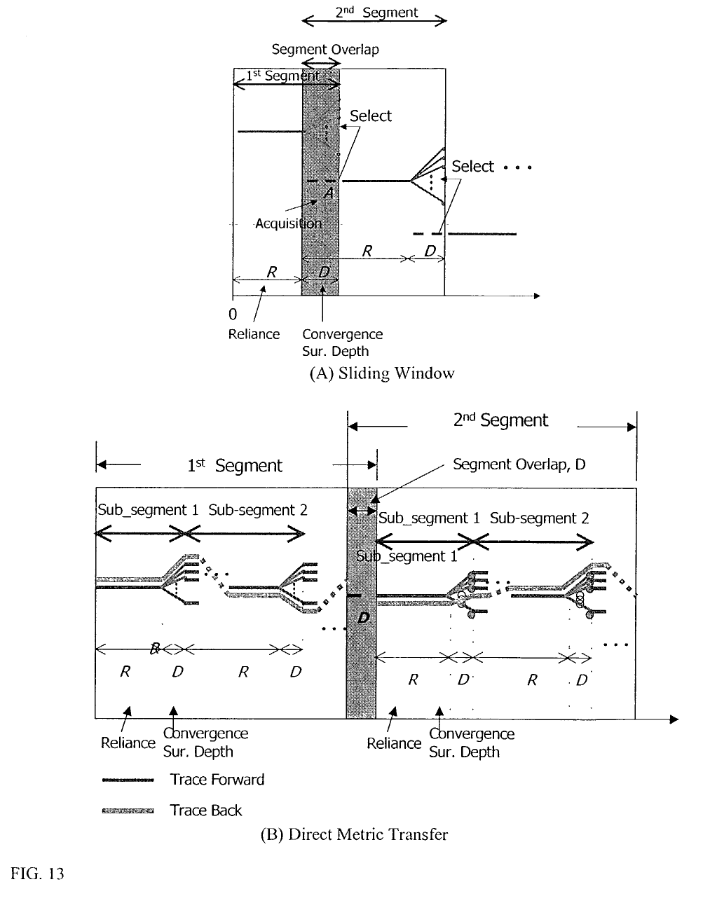

In a typical Viterbi decoder, depending on the data frame size and the memory availability for each specific implementation, the decoder processing can be performed on the received sequence as a whole, or the original frame can be segmented prior to processing. The latter case would require a sliding window approach in which state metrics computation of segment (window) i+1 will be done in parallel to the trace back computation of segment i as shown in FIG. 13 (i.e. overlap between windows).

For optimum performance using an RC array 102, an alternative approach to a sliding window is provided which eliminates the need for overlap during metric calculation. This approach is based on direct metric transfer between consecutive sub-segments. More specifically, each segment within a frame is divided into non-overlapping sub-segments which are processed sequentially by direct metric transfer. The data frames are first buffered and then applied to the RCs 206 configured as the Viterbi decoder. The buffer length is the segment length plus survivor depth of the decoder. The Viterbi decoder performs a standard Viterbi algorithm by computing path metrics stage by stage until the end of sequence is reached.

The received data sequence is then traced back using the present method which consumes up to about 20% less cycles as compared to conventional trace back methods. In addition, when sub-segments are not initialized (i.e. for the intermediate sub-segments), the next sub-segment would use the survivor metrics of a previous sub-segment as its initial condition.

This results in a reliable survivor calculation at the beginning of a new sub-segment with no need for overlap or initialization. The sliding window approach applied to the segments avoids the unreliable period by introducing an overlap between consecutive segments. Depending on the method, the overlap can be D (survivor depth) or D+A (survivor depth plus acquisition period). At the same time however, it leads to a Viterbi decoder performance which is virtually independent of the segment length, as illustrated in FIG. 13. Therefore, small buffers can be used prior to the RCs 206 which are configured as the Viterbi decoder, which can also reduce power consumption.

### Branch Metric Normalization

The value of path metrics in the add, compare and select (ACS) stage (stage 2) grows gradually stage-by-stage. Due to finite arithmetic precision, the result of an overflow changes the survivor path selection and hence decoding may become invalid. There should be a normalization operation to rescale all path metrics to avoid this problem. Several methods of normalization are described below.

Reset: Redundancy is introduced into the input sequence in order to force the survivor sequence to merge after some number of ACS recursion for each state. Using a small block size, so that the path metrics cannot grow beyond the 16 bit precision of the registers, is also an alternative.

Difference Metric ACS: The algorithm is reformulated to keep track of differences between metrics for each pair of states.

Variable shift: After some fixed number of recursions, the minimum survivor path is subtracted from all the survivor metrics.

Fixed shift: when all survivor metrics become negative (or all positive), the survivor metrics are shifted up (or down) by a fixed amount.

Modulo Normalization: Use the two's complement representation of the branch and survivor metrics and modulo arithmetic during ACS operations.

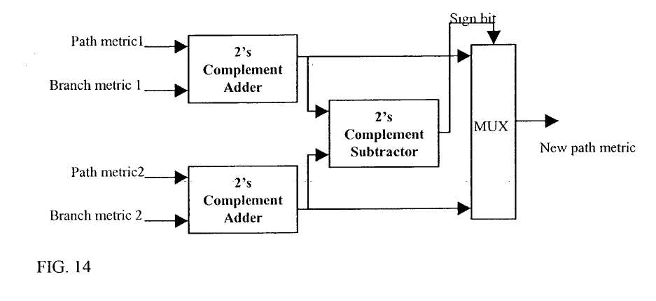

As the arithmetic logic unit (ALU) in an RC 206 preferably uses 2's complement representation, implementation of the modulo normalization can be most efficient. The comparison stage in ACS is changed to subtraction. A block diagram of the modulo approach is shown in FIG. 14.

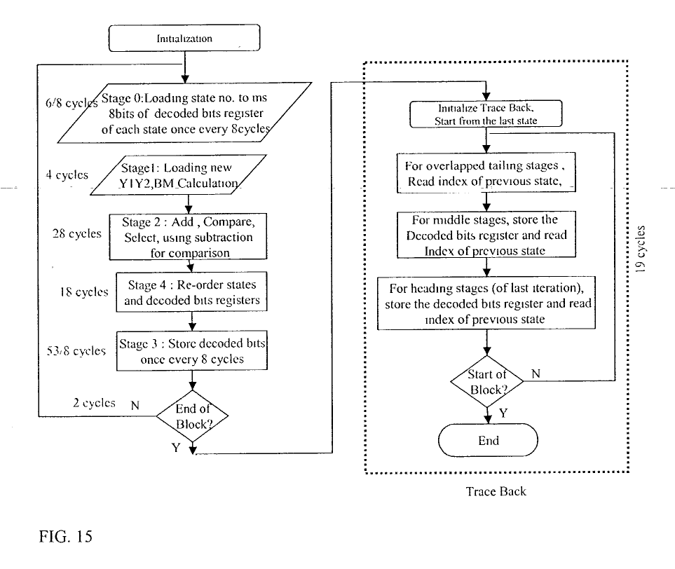

The optimization methods discussed above can be applied to the initial mapping. The conceptual flow chart of the optimized mapping is shown in FIG. 15. As can be seen, there is a new stage 0 for loading a state number for every register allocated to decoded bits. For each state there is at least one register for path metrics and another register for decoded bits. Initial state numbers are loaded to bits 8-15 of each decoded bits register at this stage. As 8 bits are used for state index and the rest of the 8 bits for decoded bits of 8 subsequent trellis stages, stage 0 is executed once per 8 iterations.

Stage 2 is modified for subtraction instead of comparison to comply with modulo normalization. Applying the hybrid trace back and register exchange method, there is no need in stage 3 to store survivor paths. Instead, first the path metrics as well as decoded bits are reordered to move to a new state in stage 4, and then the decoded bits registers of all states (once it is full) are stored. The frequency of execution of stage 3 will now be once every 8 trellis stages. However the amount of data is roughly equivalent to 256 16-bit registers.

In trace back stage, as shown in FIG. 13, there are three trace back sections. Section D is associated with overlapped tailing stages. The decoded bits are not stored, and will be overwritten by the next block. The middle part however is the final decoded bit section and the result is stored. Also the A part, corresponding to the tail part of previous block, is now used to store the decoded bits of heading part.

The loops for these 3 sections are not shown in the flow chart in FIG. 15. As discussed before, 8 decoded bits are fetched at every execution of trace back loop. The trace back jumps from stage i to stage i-8 on the trellis diagram, and ⅛ of cycle count for trace back will be reflected to final cycles/bit.

### Mapping Variations

Although the previous sections generally describe implementation of a Viterbi algorithm for K=9 and R=½, embodiments of this invention can be applied to other cases as well. For other encoding rates, only the first stage of the mapping should be changed, and instead of reading two bytes, n bytes (R=1/n) may be read. Puncturing also can be applied to this stage for other rates. Other constraint lengths require different state assignments to the RC array. This can affect the implementation of the basic stages and consequently the cycles/bit figure.

### Parallel Multi-Block Viterbi

With access to multiple blocks of input encoded data, different mappings can be used to perform parallel Viterbi decoding processes on multiple blocks of RCs. To do this, the mapping can be changed so that only a small part of the RC array 102 is assigned to one Viterbi decoding. That is, there can be more states associated with every RC 206.

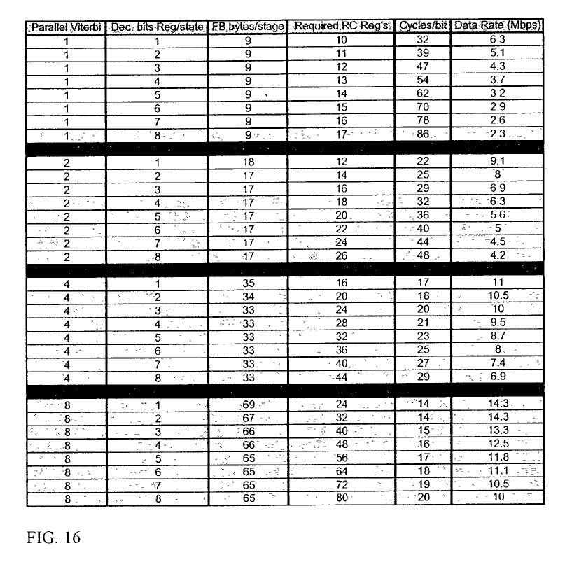

Parallel mapping is preferred if there are enough registers in each RC to accommodate more states. FIG. 16 illustrates the effect of parallel Viterbi execution on cycle count, for a Viterbi decoding process with constraint length of 7 and coding rate of ½. The dark area shows the cases that cannot be efficiently implemented on the rDSP due to a shortage of registers. As the parallelism increases, fewer RCs are used for each parallel Viterbi. Hence the number of registers grows and the cycle count improves.

It can also be seen that using more than one register per state for keeping decoded bits reduces the speed. Although using more registers leads to less frequent writing of decoded bits into the frame buffer as well as a fewer number of trace back loop executions per bit, shuffling these registers together with state registers takes more cycles.

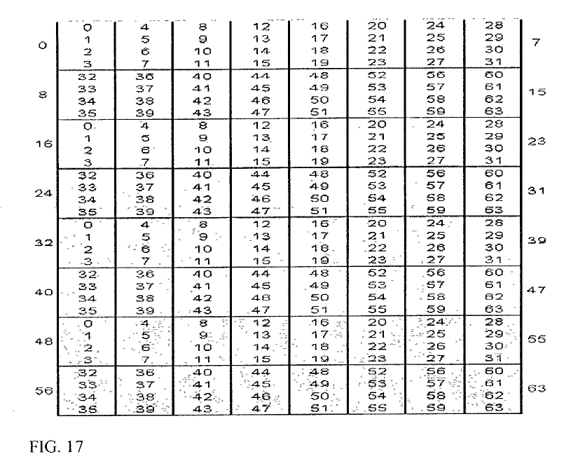

An implementation of a Viterbi algorithm for K=7, R=½ on 2 rows of RCs, for a total of four parallel decoding process, includes similar stages as discussed above. FIG. 17 shows the state assignment to the RCs. Every two rows of RCs perform a separate Viterbi decoding, as shown:

▪Loop 1:

♦Stage 0:

♦Update working condition registers (1)
♦Loop overhead (p)

♦Stage 1:

♦Reading Y1 Y2 (p)
♦Split Y1, Y2 (1 − 2)
♦ADD Y1 + Y2 (1)
♦SUB Y1 − Y2 (1)

♦Stage 2:

♦Set flag for condition (p)
♦Branch metrics computation (2*p)
♦Set flag (p)
♦New path metrics (p)
♦Decoded bit detection (p)
♦Store Decoded bit (p)

♦State 3:

♦Store in FB every 16*m − 1 cycles
(p*(8*m + 2)/(16*m − 1))

♦Stage 4:

♦Shuffle (8*m + 8)

▪Loop 2:

♦Trace Back:

♦Once every 16*m − 1 cycles ( 25*p/(16*m − 1))

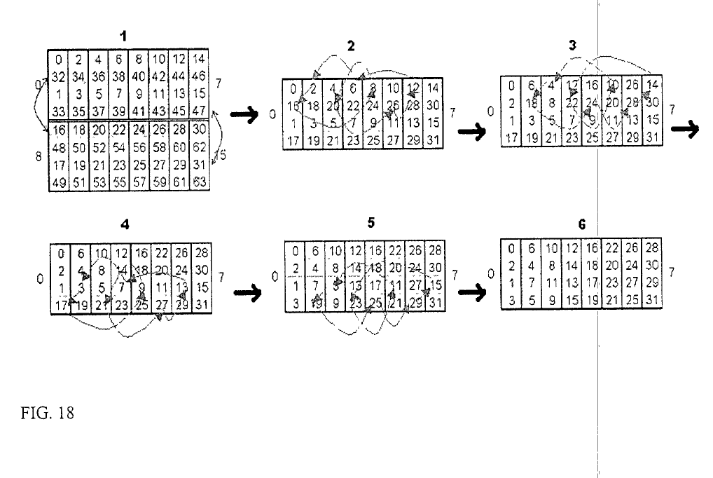

Here, p is the number of parallel Viterbi processes, and m is the number of registers assigned to decoded bits for each state. The reordering stage in this mapping uses a different permutation, illustrated in FIG. 18, in which K=7 and P=4. The first step is row-wise between 2 rows of each row pair, and the rest are column-wise, and the same for all rows. However, in the last permutation, every RC has proper states, but the register orders may be incorrect. Extra registers can be used in intermediate moves to eventually achieve a proper order of register-states.

Another alternative mapping method uses a limited number of RCs for Viterbi decoding. This can be the result of using an RC array with fewer RCs in order to reduce power consumption and reduce area or footprint of the array. The method of mapping is basically similar to the parallel Viterbi decoding method discussed above. For constraint length of K=7, the code is mostly the same as that of the previous section. However the degree of parallelism changes and as a result the cycles/bit will be several times higher.

For constraint length of K=9, there may be insufficient storage in each RC to keep the entire states. Accordingly, it is necessary to load/store the path metrics from/to frame buffer after each trellis stage. The preferred mapping includes assigning eight registers for eight states. Hence, two rows of an RC array can accommodate 128 states, and the operations can be simply re-executed on the next 128 states.

The hybrid trace back method may not be efficient in this case. The path metrics are stored at every iteration into memory and there is no benefit of reducing the frequency of execution of stage 3. In addition, the portion of cycles for trace back is very small compared to that of other cases. The extra burden of the hybrid method on shuffling stage is now important. The trace back method with survivor path accumulation, discussed above with reference to stages 2 and 3 of the preliminary mapping, is applicable. Other optimization methods may be used as before.

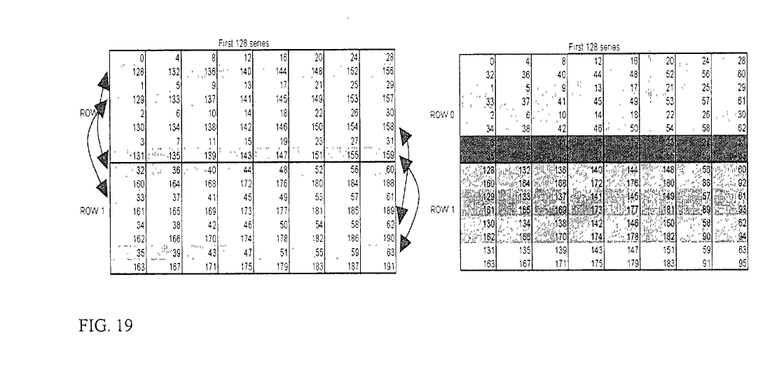

The shuffling stage is different in this alternative approach and is illustrated in FIG. 19. There are four register exchanges between two rows (left), and for each pair of registers in every row there are two shuffling steps similar to steps 2 and 3 of FIG. 18. There is another series of similar steps for the second series of 128 steps, performed after storing the result of first series and loading the second series.

The number of cycles for data shuffling in mapped algorithm is 27. But the total cycles of stage 4 is 110 cycles, and most of the cycles will be used for data movement from and to the frame buffer. The total number of cycles is therefore 4.7 times that of the basic mapping scheme. The total memory usage is less, as the volume of data stored for survivor path is roughly half (i.e. no need to store the index). The evaluation is based on an encoded bits block size of 210 and an overlap of 96 as before.

### Bit Error Rates

A series of simulations were performed on MATLAB and MULATE to study the performance of the above implementation. In the simulations, the encoded outputs are assumed as antipodal signals. At the receiver end, these levels are received in noise (AWGN channel assumption). A soft input Viterbi decoder is implemented in which the received data is first quantized (with an 8-bit quantizer) and then applied to the Viterbi decoder. Compared to the hard decision, the soft technique results in better performance of the Viterbi algorithm, since it better estimates the noise. The hard decision introduces a significant amount of quantization noise prior to execution of the Viterbi algorithm. In general, the soft input data to the Viterbi decoder can be represented in unsigned or 2's complement format, depending on the quantizer design. The quantizer is assumed to be linear with a dynamic range matching its input data.

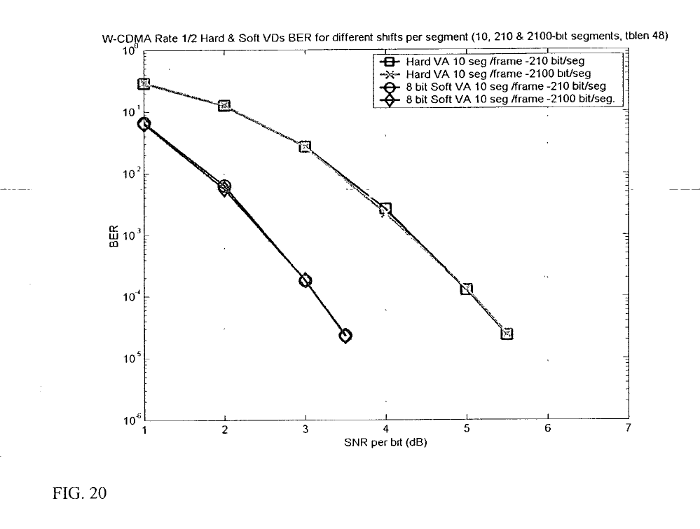

It is also assumed that the data frame contains a minimum of 210 bits, as is the case for voice frames. The maximum frame length directly relates to the frame buffer size. FIG. 20 summarizes the MATLAB simulation results for frame lengths of 210 and 2100 for both 8-bit soft and hard Viterbi decoders. Hard and soft Viterbi decoder results are presented as measures of upper and lower bit error rate (BER) bounds. Soft decoding has a 2 dB gain in signal-to-noise ratio (SNR) as compared to hard decoding at BERs of about 1×e⁻⁵. In addition, there is no significant performance difference between segments of 210 bits and 2100 bits.

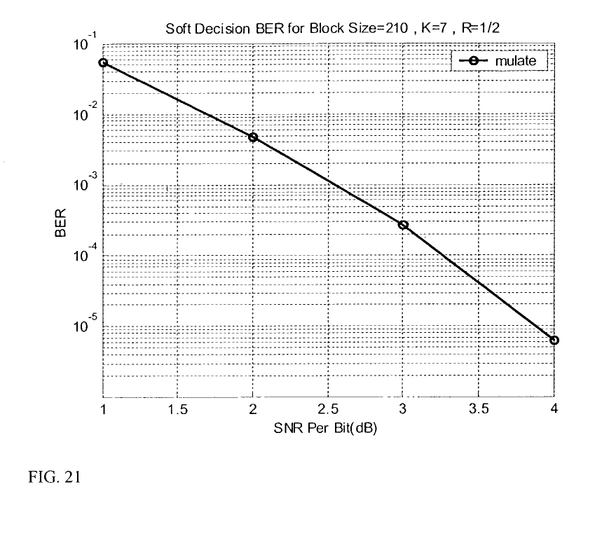

The simulation result of MULATE is illustrated in FIG. 21. The BER of MULATE is extracted out of a simulated 400 random packets for SNR 1-3 dB and 8000 for SNR 4 dB.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. In a digital signal processor having a local memory and a global memory, a hybrid register exchange and trace back method used for decoding convolutional encoded signals, comprising:
accumulating segments of decoded bits associated with each survivor path for a number of trellis stages in the local memory.

2. The method of claim 1, further comprising transferring, after a number of trellis stages, said segments of decoded bits from the local memory to the global memory.

3. In a digital signal processor decoding convolutional encoded signals, wherein the digital signal processor includes a core processor and a plurality of reconfigurable processor cells arranged in a two dimensional array, a method for connecting segments of decoded bits associated with every survivor path comprising:
assigning an initial state number to each segment of decoded bits corresponding to a survivor path; and
buffering segments of the decoded bits within at least a portion of the plurality of reconfigurable processing cells.

4. In a digital signal processor executing a Viterbi algorithm for decoding convolutional encoded signals, wherein the digital signal processor comprises a core processor and a plurality of reconfigurable processor cells arranged in a two dimensional array, a method for normalizing path metrics associated with every survivor path at every trellis stage, comprising:
executing a modulo arithmetic with at least a portion of the plurality of reconfigurable processor cells based on two's complement subtraction in an add, compare, and select (ACS) stage of the Viterbi algorithm.

5. In a digital signal processor, comprising a core processor and a plurality of reconfigurable processor cells arranged in a two dimensional array, a method for parallel decoding of convolutional encoded signals, comprising:
assigning multiple portions of said plurality of reconfigurable processor cells to decode multiple segments of the convolutional encoded signals.

6. The method of claim 5, further comprising configuring at least one portion of said plurality of reconfigurable processor cells to decode convolutional encoded signals with variable constraint lengths and encoding rates.

7. In a digital signal processor, a method for reducing memory usage and computational overhead in decoding convolutional encoded signals, comprising:
executing a combination of parallel and serial Viterbi decoding based on a sliding window and a direct metric transfer.
